(19) United States
(12) Patent Application Publication
(10) Pub. No.: US 2014/0300729 A1
(43) Pub. Date: Oct. 9, 2014

(54) Probe for Inspection System

(71) Applicant: United Technologies Corporation, Hartford, CT (US)

(72) Inventors: Joseph D. Drescher, Middletown, CT (US); Eric M. Pedersen, Cheshire, CT (US); Kevin J. Klinefelter, Uncasville, CT (US); Markus W. Fritch, Manchester, CT (US)

(21) Appl. No.: 14/310,644

(22) Filed: Jun. 20, 2014

Related U.S. Application Data
(63) Continuation-in-part of application No. 12/772,510, filed on May 3, 2010, now Pat. No. 8,797,398.

(51) Int. Cl. G01N 21/88

(52) U.S. Cl. CPC G01N 21/8803
USPC 348/92

(57) ABSTRACT

A method and system are provided for inspecting a plurality of target features arrayed in spaced arrangement on a surface of a target object, such as but not limited to inspection of the location of cooling air holes in the surface of a turbine blade or vane.

### CROSS-REFERENCE TO RELATED APPLICATIONS

This patent application is a continuation-in-part of U.S. application Ser. No. 12/772,510, filed on May 3, 2010, entitled “On-The-Fly Dimensional Imaging Inspection.”

### FIELD OF THE INVENTION

The present disclosure relates generally to systems and methods for inspecting manufactured articles and, more particularly, relates to systems and methods for inspecting multiple features on a manufactured article.

### BACKGROUND OF THE INVENTION

Gas turbine engines, such as those used to power modern aircraft, include a compressor for pressurizing a supply of air, a combustor for burning fuel in the presence of high pressurized, compressed air to generate and accelerate high temperature, high velocity combustion gases, and a turbine for extracting energy from the resultant combustion gases. The combustion gases leaving the turbine are exhausted through a nozzle to produce thrust to power the aircraft. In passing through the turbine, the combustion gases turn the turbine, which turns a shaft in common with the compressor to drive the compressor.

As the hot combustion gases pass through the turbine, various turbine elements, such as the turbine stator vanes and turbine rotor blades of the turbine, are exposed to hot combustion gases. In order to protect these turbine elements from exposure to the hot combustion gases, it is known to cool the turbine blades and vanes. In order to facilitate cooling of the blades and vanes, it is known to form the turbine blades and vanes with complex systems of internal cooling passages into which compressor bleed air, or another cooling fluid, is directed to cool the blade or vane. The cooling air exits the blade/vane through a system of holes arranged in such a manner that the exterior surface of the blade/vane is cooled, and is then passed out of the engine with the rest of the exhausted combustion gases.

In some turbine blade/vane embodiments, the cooling air exit holes are arranged in a specific pattern on various facets of the blade/vane airfoil to create a surface cooling film. The surface cooling film creates a layer of cool air, which insulates the airfoil from the hot combustion gases passing through the turbine. In order to ensure that the surface cooling film properly forms, various shaped exit holes are precisely located and drilled at various angles on the surface of the airfoil. Thus, after manufacture it is necessary to inspect the blades and vanes to ensure the holes are properly positioned.

Conventional inspection systems include a fixture for holding the turbine blade/vane being inspected, a video camera, and a computer for controlling the inspection process and processing the video camera images. Generally, conventional inspection systems require inspection of each cooling hole from a gun-barrel view, which typically also requires the use of a five-axis coordinate measuring machine (CMM) for orientating the element and stepping the video probe from hole to hole. Since the turbine vanes and blades may, for example, have as many as 200 to over 300 cooling holes, each cooling hole must be individually inspected.

Conventional inspection systems implement a step and stop process inspection, wherein the video camera is moved from hole location to hole location and positioned in a stationary relationship relative to the hole for a period of about 1.5 to 2.0 seconds before moving on to the next hole. This dwell time is needed for the video camera and the target hole to synchronize position for the video camera to image the target hole, and the computer to analyze the dimensional measurements and output results. The video camera has a low frame rate capability, typically only 30 frames per second. Typically, inspection of a single airfoil may take as long as ten minutes, depending upon the number of holes and also the time required in initial part probing. Part probing is required to properly position the part to be inspected in the workpiece fixture prior to initiating the actual hole inspection, which in conventional practice can take from about 1.5 minutes to over 3 minutes.

### SUMMARY OF THE INVENTION

In accordance with an aspect of the disclosure, an inspection system for inspecting a plurality of target features arrayed in spaced arrangement on a surface of a target object is provided. The system may include a position manipulator having a fixture for holding the target object. A first sensor may extend along a longitudinal axis. A second sensor may be in operative association with the position manipulator and the first sensor. The second sensor may have a deployed position and a retracted position. The second sensor may be actuatable between the retracted position and the deployed position at a non-orthogonal angle relative to the longitudinal axis. In a deployed position, the second sensor may be nominally coincident with a focal point of the first sensor.

In accordance with another aspect of the disclosure, an actuator may be in operative association with the second sensor for deployment and retraction of the second sensor.

In accordance with yet another aspect of the disclosure, the first sensor may be a camera and the second sensor may be a touch probe.

In accordance with still yet another aspect of the disclosure, a frame having a support section may support a lens that is couple to the camera.

In accordance with a further aspect of the disclosure, the support section may include a probe aperture that is in operatively associated with the touch probe such that the touch probe deploys and retracts through the probe aperture.

In accordance with an even further aspect of the disclosure, the frame may include a light array mount for mounting a light array.

In further accordance with yet another aspect of the disclosure, the actuator may be an air cylinder.

In accordance with another aspect of the disclosure, an inspection system for inspecting a plurality of target features arrayed in spaced arrangement on a surface of a target object is provided. The system may include a position manipulator having a fixture for holding the target object. The system may also include a high speed camera having an exposure duration of less than 3 milliseconds and may be configured to at least in part capture an image and determine a location of the target features. The high speed camera may enable inspecting of the plurality of selected target features without pause such that movement of the selected target feature relative to the high speed camera over a duration of a frame capture is less than a predetermined fraction of a true position tolerance of the selected target feature. The high speed camera may extend along a longitudinal axis. A light array may be in operative association with the high speed camera. A controller may be operatively associated with the high speed camera and with the position manipulator. A processor may be operatively associated with high speed camera for processing an image of a target feature received from the high speed camera. A touch probe may be in operative association with the position manipulator and the high speed camera. The touch probe may be actuated between a deployed position and a retracted position at a non-orthogonal angle relative to the longitudinal axis. In a deployed position, the touch probe may be nominally coincident with a focal point of the high speed camera.

In accordance with yet another aspect of the disclosure, an actuator may be in operative association with the touch probe for deployment and retraction of the touch probe.

In accordance with still yet another aspect of the disclosure, the light array may include a plurality of light emitting diodes.

In accordance with another aspect of the disclosure, a method for inspecting a plurality of target features arrayed in spaced arrangement on a surface of a target object is provided. The method entails providing a fixture for holding the target object. Another step may be providing a first sensor extending along a longitudinal axis. Yet another step may be providing a second sensor being in operative association with the fixture and the first sensor. In the deployed position, the second sensor may be nominally coincident with a focal point of the first sensor. A further step may be deploying the second sensor at a non-orthogonal angle relative to the longitudinal axis so that the second sensor, in the deployed position, is nominally coincident with a focal point of the first sensor. Yet another further step may be determining, with the second sensor, a datum set of the plurality of target features. An even further step may be retracting the second sensor. Still another step may be selectively positioning at least one of the fixture and the first sensor relative to the other for inspection, with the first sensor, of a plurality of selected target features.

In accordance with yet another aspect of the disclosure, the first sensor may be a camera.

In accordance with still yet another aspect of the disclosure, the second sensor may be a touch probe.

In accordance with a further aspect of the disclosure, the second sensor may be actuated by an air cylinder.

In accordance with an even further aspect of the disclosure, a light array may be in operative association with the first sensor.

In accordance with still an even further aspect of the disclosure, selectively positioning at least one of the fixture and the first sensor relative to the other may include positioning based on the datum set of the plurality of target features.

Other aspects and features of the disclosed systems and methods will be appreciated from reading the attached detailed description in conjunction with the included drawing figures. Moreover, selected aspects and features of one example embodiments may be combined with various aspects and features of other example embodiments.

### BRIEF DESCRIPTION OF THE DRAWINGS

For a further understanding of the disclosure, reference will be made to the following detailed description which is to be read in connection with the accompanying drawings, where:

FIG. 1 is a block diagram schematic illustrating an exemplary embodiment of an inspection system for on-the-fly inspection of a plurality of target features associated with a part to be inspected;

FIG. 2 is a partially cut-away elevation view of the pressure side of a turbine having a multiplicity of cooling air holes;

FIG. 3 is a flow chart illustrating a method for on-the-fly inspection in accord with an aspect of the invention;

FIG. 4 is a perspective view of an exemplary alternative embodiment of an inspection system with portions broken away to show details of the present disclosure;

FIG. 5 is another perspective view of the exemplary embodiment of the inspection system of FIG. 4 with portions broken away to show details of the present disclosure; and

FIG. 6 is a flow chart illustrating a sample sequence of steps which may be practiced in accordance with the teachings of this disclosure.

### DETAILED DESCRIPTION OF THE INVENTION

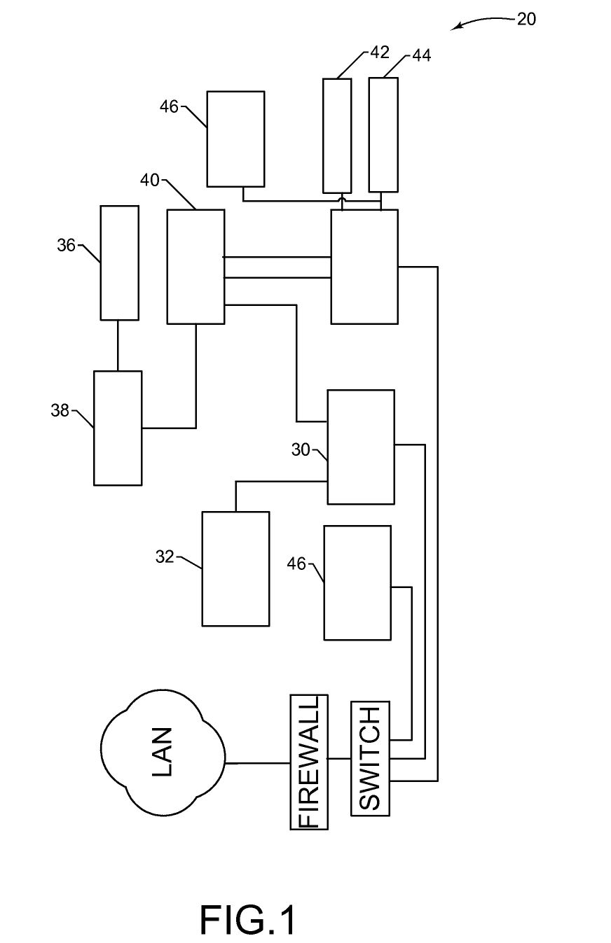

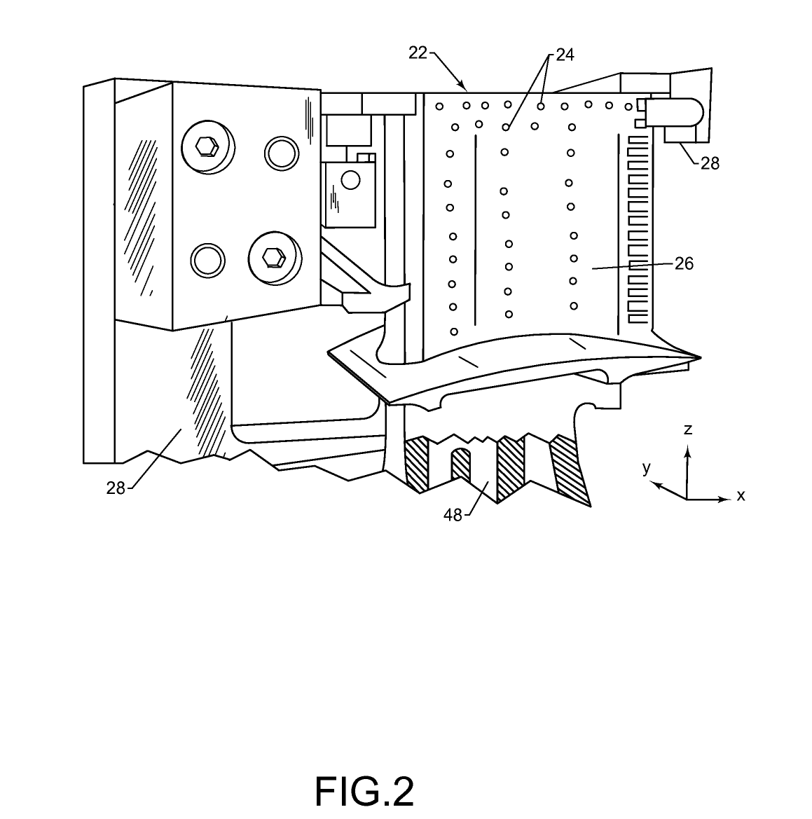

There is depicted schematically in FIG. 1 an exemplary embodiment of an inspection system 20 for quickly and accurately locating the position of multiple target features associated with an object to be inspected. For example, the inspection system 20 disclosed herein may be used and the method of inspecting disclosed herein implemented in connection with the inspection of a target object 22. The target object 22 may be, as a non-limiting example, a turbine airfoil, such as a turbine blade or vane shown in FIG. 2. The inspection system 20 may verify the actual location of target features 24 (shown in FIG. 2), such as each of a multiplicity of cooling air exit holes on the surface 26 of the turbine airfoil 22. It is to be understood, however, that the inspection system and the method for inspecting disclosed herein may be adapted for locating other features on other objects.

Referring now to FIGS. 1-2, the inspection system 20 includes a fixture 28 for holding the target part (shown in FIG. 2) being inspected, a fixture position manipulator 30, a controller 32, a processor 34, a light array 36, a light array driver 38 and a high speed camera 40. The holding fixture 28 secures the target part 22 to be inspected in a specific position relative to the holding fixture such that each part in a series of similar parts to be inspected is held in substantially the same position within the holding fixture 28 from part to part. The holding fixture 28 is secured to the fixture position manipulator 30 in a fixed position. The light array 36 is operatively associated with the high speed camera 40 and positioned for providing light on the target part to facilitate imaging of the part by the high speed camera 40. The light array driver 38 is operatively associated with the light array 36 for powering the light array 36 to illuminate the target part. The controller 32 is operatively associated with the fixture position manipulator 30 for commanding the fixture position manipulator 30 to selectively position the holding fixture 28 to orient the target part whereby the selected target feature 24 to be imaged is in a desired orientation relative to the high speed camera 40. The controller 32 also controls positioning of the high speed camera 40 and coordinates the triggering of the high speed camera 40 with the orientation of the target feature such that the high speed camera 40 is triggered and the target feature imaged when the high speed camera is in a gun-barrel shot position with respect to the selected target feature. By gun-barrel shot position/alignment, it is meant that the focal point of the high speed camera 40 is aligned along a line extending normal to the surface of the target object at the location of the target feature to be imaged.

The inspection system 20 is capable of implementing an on-the-fly inspection process in accord with the method disclosed herein. In operation, the controller 32 controls positioning of the target part by manipulation of the fixture position manipulator 30 in a controlled coordinated manner with movement of the high speed camera 40 whereby continuous relative movement along a specified, arbitrary three-dimensional path over the plurality of selected target features to be imaged is maintained between the high speed camera 40 and the target part as the multiplicity of target features are imaged without pause. That is, the high speed camera does not stop and dwell over any target feature location during imaging of that location on the target part. Rather, in accord with the process disclosed herein, the high speed camera 40 and the selected target feature to be imaged are in relative motion at a constant speed as the high speed camera is triggered and images the selected target feature. By eliminating the dwell time over the part at each inspection site, the inspection time associated with inspecting an individual target feature, such as a cooling air hole on a turbine airfoil, is significantly reduced relative to the conventional step and stop inspection method.

In on-the-fly inspection as disclosed herein, the movement of the target feature of interest relative to the high speed camera 40 over the duration of the frame capture must be less than a reasonable fraction, such as for example 1/10^{th}, of the true position tolerance of the target feature. Thus, in implementing the on-the-fly inspection method disclosed herein, the speed of movement of the high speed camera 40 is primarily limited by the frame rate capability of the camera 40 and the ability of the high speed camera 40 to collect enough light during the exposure duration for adequate contrast so that the image of the target feature can be resolved. Generally, the high speed camera 40 should have an exposure duration, i.e. time required for imaging a target feature, of less than three (3) milliseconds. For example, a high speed camera having a frame rate capability of at least about 300 frames per second would enable imaging with relative motion between the camera and the target feature at a constant speed of at least about 50 inches per minute.

The light array 36 is provided for illuminating the target feature with sufficient light at least during the exposure duration, that is at the time the high speed camera 40 images the target feature. The light array 36 comprises a plurality of high intensity light emitting devices, for example light emitting diodes (LEDs), arranged to illuminate the target feature to provide adequate contrast. The number of light emitting diodes comprising the light array 36 depends upon the power level applied to drive each diode. If a higher power level is applied per diode, for example about one watt or more per diode, the number of light emitting diodes may be decreased. Conversely, if a lower drive power level per diode is desired, a greater number of light emitting diodes may be provided. However, conventional low power, i.e. low wattage, LEDs commonly used in commercial applications do not provide sufficient light output per diode to be used in implementing the on-the-fly inspection method disclosed herein. The number of LEDs may also be reduced if a means of focusing is provided in association with the light emitting devices forming the light array 36 to increase the flux (intensity per unit area) in the image field of view of the high speed camera 40. The LEDs making up the light array 36 may be arranged in a ring pattern, in a single row, a double row or any other suitable arrangement.

The light array driver 38 is controlled by the controller 30 through the high speed camera 40 to power the light emitting devices comprising the light array 36. Although the light array could be powered continuously during the inspection process, doing so creates excess heat and shortens the life of the lights. In implementing the method disclosed herein using a high speed camera, the light array 36 may be powered in synchronization with the imaging of the target feature by the high speed camera 40. When the high speed camera 40 is moving over the target feature, the high speed camera 40 triggers the light driver 38 to power the light array 36 to illuminate the target feature during the exposure duration. With LEDs making up the light array 36, the light driver 38 comprises a LED driver having the capability of selectively switching the light array LEDs from zero power to at least full power in less than one microsecond to flash the LEDs in coordination with the camera exposure duration. Precise coordination of the camera exposure duration and the LED flash duration is particularly important at the higher relative speeds of movement between the high speed camera 40 and the target feature to be imaged that may be used in implementing the on-the-fly inspection method disclosed herein to eliminate blurring and ensure clarity of the image of the target feature.

Additionally, the LED driver can have the capability of over-powering the light array LEDs, that is powering individual LEDs of the light array 36, all or selected LEDs thereof, at a power level in excess of the full rated power of the LED. Although over-powering the LEDs is not required when implementing the on-the-fly inspection method disclosed herein, over-powering the LEDs produces a “strobing-like” effect that may improve image contrast and clarity during the exposure duration. This effect is not possible to attain with conventional lights, such as incandescent or halogen lights. The light array LEDs are arranged such that directional control is available for adjustment of the geometry comprising the orientation of the optical axis of the camera lens, the light from the LEDs, and the target part orientation surrounding the feature of interest. Adjustment may be achieved by selectively controlling, through software control, the intensity of each available light array LED at its respective location with respect to the target feature.

As noted previously, conventional step and stop inspection systems typically employ a 5-axis, coordinate measuring machine in combination with a low speed video camera. Such machines can move the video camera and/or the part to a location and orientation very well in a step and stop inspection process even though each axis may arrive at its individual target location at a different time. However, conventional coordinate measuring machines do not have the ability to control three linear and two rotary axes in a coordinated fashion for imaging while in motion as required in implementation of the on-the-fly inspection method disclosed.

In the on-the-fly inspection system 20, the fixture position manipulator 30 comprises a computer numerically controlled (CNC) machine under direct control of the controller 32. The CNC machine 30 secures the fixture 28 that holds the target object to be inspected. The CNC machine 30, under the control of the controller 32, provides coordinated five degree of freedom motion control for maneuvering the fixture 28 in the CNC machine 30 to align the target object to a desired orientation with the high speed camera 40 for imaging of the selected target feature. CNC machines with coordinated 5-axis motion control are known for use in the aerospace industry for machining applications, for example where the location and orientation of a cutting tool relative to the workpiece is important at all times when the two are in contact. However, the use of CNC machines with coordinated five degrees of freedom motion control is novel in inspection applications for imaging a target feature on a target object with a high speed camera while in relative motion along a three-dimensional path without the stop and step required in practice.

As noted above, in on-the-fly inspection as disclosed herein, the high speed camera 40 images the target feature while in relative motion with respect to the selected target feature at a constant speed. Depending upon the relative speed and the spacing between target features, the high speed camera 40 may be imaging several target features a second. Therefore, the inspection system must be capable of handling the images produced in such a manner as to not adversely impact control loop cycle time of the controller 32. During a single control loop cycle, the computer 34 will receive a signal from feedback devices of each axis as the actual position, modify this position of each axis with any active corrections as applicable, compare the result to the commanded position at that time, and output power signals to each axis motion control device (usually a motor) associated with the fixture position manipulator 30 subject to the various control parameters (tuning) which have been set. The control loop cycle time should desirably be around 1 millisecond or less. Performing analysis of images and performing other output functions during the “random” cycles when the images are available (1 in 150 cycles for example) in such a way that the cycle time can be maintained reliably would severely limit what the cycle time could be achieved and consequently may limit the speed of measurements.

Accordingly, the inspection system 20 incorporates a parallel processor 34 for performing image analysis. Whenever the high speed camera 40 images a target feature, the single frame image is captured by the high speed camera 40 and stored to memory as a file in data archive 42. The processor 34 will access the image file, read the image file, analyze the image, determine the location of the target feature, for a hole center, and create the output data while the high speed camera and target object are in motion to align on the next target feature of interest. In conventional stop and step inspection methods, the image analysis was performed while the video camera remained stationary in front of the imaged target feature. In the on-the-fly inspection method disclosed herein, the image analysis occurs while the high speed camera and the target object are in relative motion along a three-dimensional path at its constant speed as the next target feature is brought into a gun-barrel shot alignment with the high speed camera. Therefore, image analysis does not adversely impact control loop cycle time. If desired, an additional processor 46 may be provided in parallel with the processor 34 to assist in processing the images. Each of the processors 34 and 46, as well as the controller 30, may be commercially available microprocessors, each of which is typically associated with a separate computer monitor, memory bank and peripherals, but two or more of which may be associated with a common computer monitor, memory bank and peripherals, if practical from a logistics and processing viewpoint.

As an exemplary embodiment, the on-the-fly inspection method will be described further as implemented for the inspection of turbine airfoils for the purpose of verifying the position of a multiplicity of cooling air holes. Referring to FIG. 2. there is depicted an exemplary embodiment of a turbine airfoil 22 having a multiplicity of cooling air exit holes 24 arranged generally in a column and row fashion on the pressure side surface 26 of the airfoil 22. The root or bottom of the airfoil 22 is shown in cut-away to reveal cooling air passages 48. To cool the turbine airfoils during operation of the gas turbine engine, high pressure air, typically compressor bleed air, enters the cooling passages 48, which extend into the interior of the turbine airfoil 22. At least a portion of the cooling air exits from the cooling air passages 48 through the cooling air exit holes 24 to flow along the exterior surface of the turbine airfoil 22. The multiplicity of cooling air exit holes 24 must be arranged in a precise pattern designed to achieve complete cooling coverage of the surface of the turbine airfoil 22. In an exemplary embodiment of a turbine airfoil, over 300 cooling air exit holes 24 may be provided with the cooling air exit holes 24 typically having a diameter of about 300 microns and typically being spaced apart at about 0.200 inches.

The on-the-fly inspection method disclosed herein can be used for verifying the precise actual location of each cooling air exit hole 24 on the turbine airfoil 22. To begin, through the user interface, which may be a dedicated computer terminal or a computer terminal in a network system, the operator selects the appropriate program for the turbine airfoil (blade or vane) to be inspected from a list of available part programs. The airfoil to be inspected, for example turbine airfoil 22, is loaded in a known manner in the fixture 28 of the fixture position manipulator 30, which in this implementation of the method comprises a five degree of freedom CNC machine. The high speed camera 40 and the holding fixture 28 are supported in the CNC machine 30 in spaced, facing relationship. The high speed camera 40 may be supported for movement in one or two linear degrees of freedom, while the holding fixture 28 is supported for movement in both rotational degrees of freedom and at least one linear degree of freedom. In a typical installation, the high speed camera 40 would be supported above the fixture and at least moveable along a vertical axis up and down relative to the turbine airfoil held in the holding fixture 28. With a turbine airfoil loaded onto the CNC machine 30, the location and orientation of the turbine airfoil with respect to each of the five degrees of freedom of the CNC machine 30 can be estimated based on the design of the holding fixture 28. As in conventional systems, the design of the holding fixture 28 includes the fixing of the turbine airfoil 22 to the holding fixture 28 in a repeatable consistent manner from airfoil to airfoil as well as the means of fixing the holding fixture 28 to the CNC machine 30 in a consistent manner.

It is difficult to know the location and orientation of the turbine airfoil with respect to the CNC machine to a level of accuracy required for the measurement of feature locations. This is due to the influence of variations that arise from actual dimensions of the turbine airfoil and holding fixture within their respective machining tolerances as well as the non-repeatability of airfoil loading and fixture loading. Because of the careful design and process controls that would be required to position the part deterministically to within the required limits, a touch-trigger probe is used to simply find the actual location and orientation of each individual turbine airfoil prior to its measurement. The part datum planes are established by measuring the location of 6 specific points on the surface of the turbine airfoil.

In conventional practice for hole inspection on turbine airfoils using the step and stop method, the accurate determination via part probing usually involves multiple iterations of the 6-point probing sequence for which each successive sequence improves accuracy in the determination of the part location and orientation. Iterations are required due to curvature on the surface in the vicinity of the specified datum points. If there is no curvature of the surface in the vicinity of the datum points, it is feasible to find the location and orientation of the part in one iteration of the probing sequence. In existing applications, part probing consumes from a tenth to a third of the total measuring time. It is a fixed time so the percent of total depends on the number of holes to be inspected, which is the variable time depending on individual part program.

However, if the same conventional part probing methods were to be used when implementing the on-the-fly inspection method disclosure herein for turbine airfoil cooling air hole inspection, the part probing portion of the measurement cycle could be expected to approach 75% even when a turbine airfoil has a relatively high number of holes to be inspected. Therefore, to shorten overall inspection time and take full advantage of the time saving associated with on-the-fly inspection, when implementing the on-the-fly inspection method the nominal location and orientation of a turbine airfoil loaded into the CNC machine 30 will be what was found as the actual location and orientation of the most previous turbine airfoil inspected, thereby reducing the potential variation to only the repeatability of the part loading and the variation within tolerances of the locating surface of the part. Additionally, the touch-trigger probe to be used will consist of two distinctly calibrated positions. The first position being the sphere at the end of the stylus and the second position being the cylinder of the stylus shaft itself at a specified location up from the sphere center. When the calibrated cylindrical portion of the probe is used on a surface datum point having curvature, it creates a line/point contact and eliminates errors due to curvature in one direction. Further, prior to initiation the probing sequence of the 6 datum points, a single point will be probed to establish a very good estimate of the turbine airfoil location along the part Z-axis. These changes will reduce the required probing to a single iteration for most parts and reduce the probing time from around 100 seconds associated with conventional probing practices to less than 50 seconds.

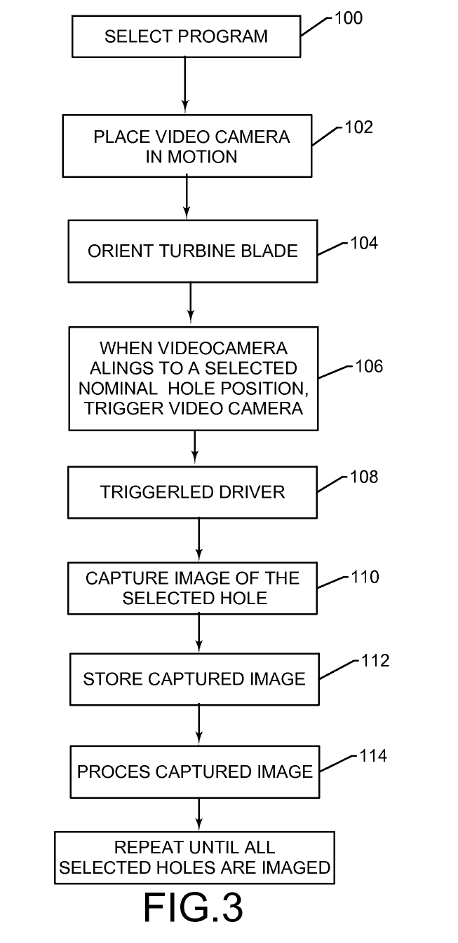

Referring now to FIG. 3, when the operator selects the appropriate program associated with the turbine airfoil to be inspected, at step 100, the selected program will be loaded into the controller 32. The program will consist mainly as a list of positions for each of the 5 degrees of freedom associated with the CNC machine 32, i.e. 3 linear degrees of freedom (x, y and z coordinate axes) and two rotational degrees of freedom (one about the axis of the holding fixture and one in a plane orthogonal to the axis of the holding fixture). These positions correspond to the nominal locations of the holes to be inspected. The camera settings for the high speed camera 40, which in this implementation of the method disclosed herein comprises a video camera, are configurable by the data link with the controller 32. When a part program is selected, the controller 32 will make the previously specified settings on the video camera for that particular part program.

The actual inspection cycle begins with the computer, at step 102, placing the video camera 40 in motion and, simultaneously at step 104, maneuvering the fixture 28 holding the turbine airfoil. The video camera 40 and turbine airfoil are in relative motion along a three-dimensional path at a constant relative speed to orient the turbine airfoil and the video camera such that the next to be imaged target hole and the video camera are brought into gun-barrel shot alignment. For example, the video camera and the turbine airfoil may be in relative motion along a three-dimensional path at a constant relative speed of at least about 50 inches per minute between holes in a row/column of holes 24 and at an even higher relative speed, for example about 200 inches per minute, between rows/columns of holes 24. The controller 32 controls the CNC machine 30 to maneuver the fixture 28 and relative movement of the video camera to properly orient the turbine airfoil 22 with respect to the video camera 40 for imaging of each individual hole 24 of the multiplicity of cooling air holes 24 on the surface of the turbine airfoil 22.

At step 106, at each instant during the inspection cycle that the video camera 40 aligns in gun-barrel shot relationship to a nominal hole position, the controller 32 sends a signal to the video camera 40. At step 108, upon receipt of that signal from the controller 32, the video camera 40 triggers the LED driver 38 which in turn powers, that is switches from zero power to full power, the LEDs of the light array 36 for a preset duration. At step 110, in synchronization with the flashing of the LEDs of the light array 36, the video camera 40 captures an image of the target hole 22 as the video camera passes over the target hole.

At step 112, the captured image is stored in a designated folder in the data archive 42 associated with the processor 34. At step 114, the captured image is accessed and processed in parallel with the movement of the video camera 40 and the maneuvering of the fixture 28 while repositioning at a constant relative speed toward the next target hole. The basic result of an image analysis will be the pixel location of the centroid of the identified blob (Binary Large Object), i.e. the cooling air exit hole 24. Based on previous calibration the location and rotation of the camera pixel array is known with respect to the machine coordinate system. Also, the location and orientation of the part coordinate system is known with respect to the machine coordinate system by the nominal tool design and by the results of the part probing which refines the tool matrix to actual. Furthermore, the location and orientation of each hole 24 is specified by the engineering definition for the part with respect to the part datum planes. Appropriate coordinate transformations are carried out by the processor 34 to determine the location of each hole 24 relative to that hole's nominal, specified location. The difference is the true position error.

The on-the-fly inspection method disclosed herein is capable of performing a hole location inspection of a turbine airfoil several times faster than the time required for using conventional step and stop hole inspection methods. For example, a turbine vane having 211 holes was subject to hole measurement inspection using a conventional step and stop method using a video camera having a frame rate capability of 30 frames per second. The time required to measure all of the 211 holes was timed at 443 seconds. Implementing the on-the-fly method disclosed herein using a high speed video camera having a frame rate capability of 1000 frames per second and moving the video camera and maneuvering the orientation of the turbine airfoil at a constant relative speed of 50 inches per minute between holes in a row and at a speed of 200 inches per minute between rows, it is estimated the measurement time for measuring the same 211 holes would be reduced to 43 seconds, a ten-fold decrease. As a further example, a turbine airfoil having 330 holes was subject to hole measurement inspection using a conventional step and stop method using a video camera having a frame rate capability of 30 frames per second. The time required to measure all of the 330 holes was timed at 690 seconds. Implementing the on-the-fly method disclosed herein using a high speed video camera having a frame rate capability of 1000 frames per second and moving the video camera and maneuvering the orientation of the turbine airfoil at a constant relative speed of 50 inches per minute between holes in a row and at a speed of 200 inches per minute between rows, it is estimated the measurement time for measuring the same 330 holes would be reduced to 57 seconds, an over ten-fold decrease.

Due to the dynamics of the CNC machine and the timing of electrical components, the on-the-fly inspection method discussed herein may be slightly less accurate, but within appropriate tolerances, in determining actual hole location on turbine airfoils as the conventional stop-and-dwell inspection method. However, the synergistic effect of the combination of the high speed camera, the five degree of freedom CNC machine, the LED light array and the controller for coordinating the relative motion along a three-dimensional path between the high speed camera and the turbine with the triggering of the high speed camera to image the holes while in relative motion, provides for a much faster inspection method, more than offsetting a slight difference in accuracy. Furthermore, any slight deficiency in accuracy compared to the conventional “stop and dwell” method may be compensated for on a part by part basis.

For example, for each unique part number to be inspected, a master part is identified as a calibrated artifact. The master part is then measured on a conventional inspection apparatus in accord with a conventional “stop and dwell” method. The master part is also measured on an inspection system implementing the “on-the-fly” inspection method disclosed herein. The respective hole dimension results attained by the two methods are compared for each and every measured hole location. A table of the differences is created and loaded into the inspection program for the on-the-fly method as a x-axis correction value and a y-axis correction value for each hole location. For each subsequent part with this unique part number inspected, the appropriate correction values will be added to the actual measured dimensional values thereby “correcting” for the output results from the on-the-fly inspection method disclosed herein to conform to the conventional “stop and dwell” method, whereby accuracy of measurement does not suffer, but significant time savings are achieved.

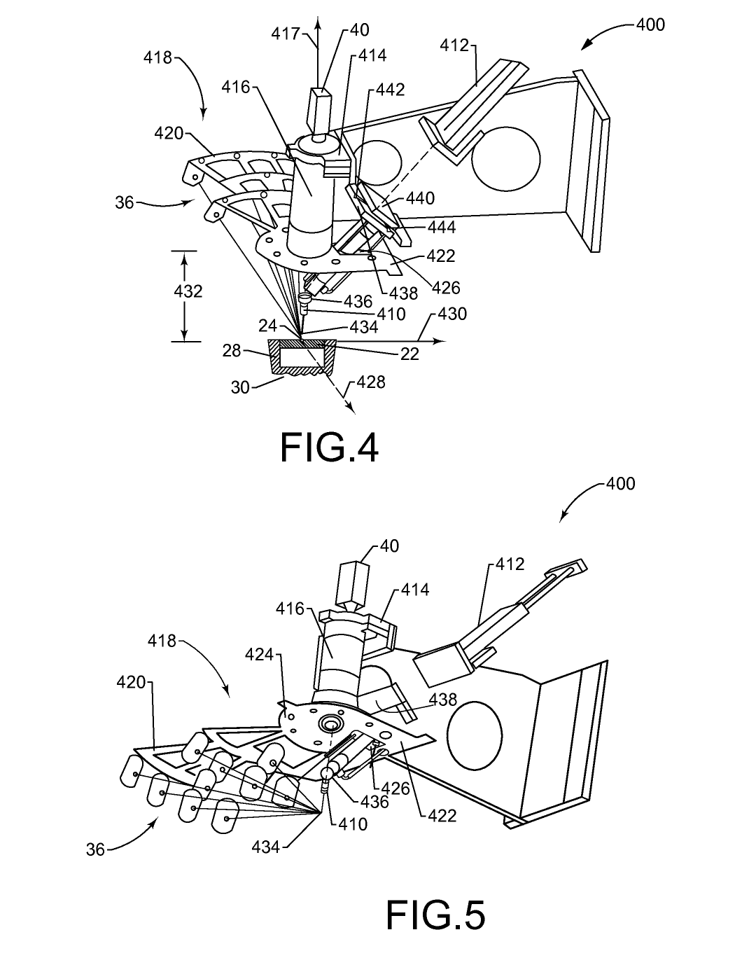

Referring to FIGS. 4 and 5, an exemplary alternative embodiment of the inspection system 20 discussed above is depicted as inspection system 400. Inspection system 400 is similar to the inspection system 20, with differences described in greater detail below. In particular, the inspection system 400 may include a sensor such as a touch probe 410. The touch probe 410 is operatively associated with another sensor such as a high speed camera 40. Touch probe 410 may be actuated by actuator 412. The actuator 412 may be, as non-limiting examples, an air cylinder, a swing arm, an articulated arm, or other appropriate actuators used for deploying and retracting the touch probe 410.

As shown, the inspection system 400 also includes a camera mounting bracket 414 for securing the high speed camera 40 and an optical lens 416, which is coupled to the high speed camera 40. A longitudinal axis 417 extends through the optical lens 416 and the high speed camera 40. Similar to inspection system 20, the inspection system 400 also includes a position manipulator 30 having a holding fixture 28. The holding fixture 28 may secure a target object 22 having a plurality of target features 24. The position manipulator 30 orients the holding fixture 28 so that one of the target features of the plurality of target features 24 is oriented in a desired orientation relative to the high speed camera 40.

The inspection system 400 also includes a frame 418. The frame 418 includes a light array mount 420 and a support section 422. The light array 36 is mounted to the light array mount 420 and is operatively associated with the high speed camera 40. Similar to other embodiments discussed above, the light array 36 may provide light on the target object 22 to facilitate the high speed camera 40 with imaging of the target feature 24. The support section 422 may include a viewing aperture 424 that corresponds with the optical lens 416 such that a housing of the optical lens 416 rests on the support section 422 and the optical lens 416 views through the viewing aperture 424. The support section 422 may also include a probe aperture 426 adjacent to the viewing aperture 424. The touch probe 410 is operatively associated with the probe aperture 426 such that the touch probe 410 may deploy and retract through the probe aperture 426.

During inspection, the position manipulator 30 orients the holding fixture 28 with the target object 22 secured thereto so that the selected target feature 24 being inspected is brought into gun-barrel shot position with the high speed camera 40. In this position, the selected target feature 24, as the focal point of the high speed camera 40, includes an x-axis 428 and a coplanar y-axis 430, which are both respectively orthogonal to the longitudinal axis 417. The selected target feature 24 is positioned a distance 432 from the optical lens 416. As a non-limiting example, the distance 432 may be approximately eight inches.

The touch probe 410 may be fully deployed through the probe aperture 426 so that the spherical tip 434 of the touch probe 410 is approximately coincident with the focal point of the high speed camera 40 when probing. Once the touch probe 410 probes (determines the datum of) each selected target feature 24, the touch probe 410 is retracted through the probe aperture 426 so that the high speed camera 40 may image the selected target features 24 for measurement. In particular, the touch probe 410 is deployed and retracted through the probe aperture 426 at an angle that is non-orthogonal to the longitudinal axis 417, the x-axis 428, or the y-axis 430. In other words, the touch probe 410 may be deployed and retracted non-linearly to the axes 417, 428, 430. With the touch probe 410 being deployed and retracted in this manner, the x- and y-axis offsets between the touch probe 410 and the focal point of the high speed camera 40 are significantly reduced compared to traditional linearly actuated touch probes.

The touch probe 410 may also include a knuckle 436, which may be adjusted, set, and locked for an appropriate angle of the spherical tip 434 to probe a selected target feature 24. Furthermore, the inspection system 400 may include a stop member 438 coupled thereto. The stop member 438 may be in operative association with a positioning member 440, which is in operative association with the actuator 412. The stop member 438 may include a plurality of grooves 442 that receive a plurality of spheres 444, which are coupled to the positioning member 440. When the actuator 412 fully deploys the touch probe 410 the positioning member 440 also deploys until the plurality of spheres 444 thereon comes to rest in the plurality of grooves 442 to ensure repeatable positioning of the touch probe 410 after each retraction and deployment.

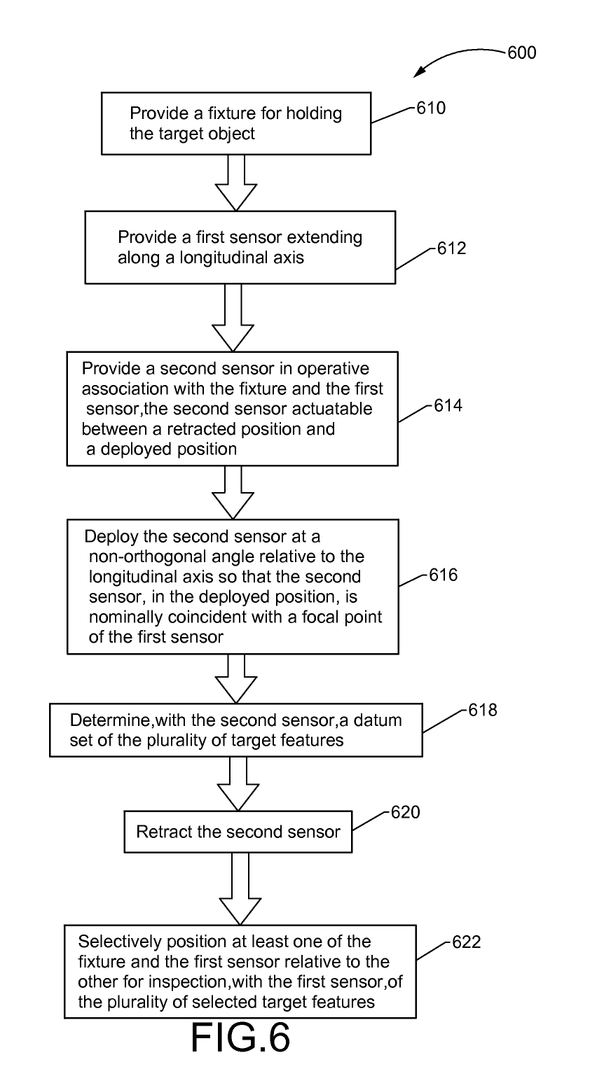

FIG. 6 illustrates a flowchart 600 of a sample sequence of steps which may be performed to inspect the plurality of target features 24 on the target object 22. Box 610 depicts the step of providing a fixture for holding the target object. Another step, as illustrated in box 612, is providing a first sensor having a longitudinal axis. Box 614 illustrates the step of providing a second sensor in operative association with the fixture and the first sensor. The second sensor may be actuatable between a retracted position and a deployed position. Yet another step, as depicted in box 616, is deploying the second sensor at a non-orthogonal angle relative to the longitudinal axis so that the second sensor, in the deployed position, may be nominally coincident with a focal point of the first sensor. Box 618 illustrates the step of determining, with the second sensor, a datum set of the plurality of target features. The step of retracting the second sensor is illustrated in box 620. Another step illustrated in box 622 is selectively positioning at least one of the fixture and the first sensor relative to the other for inspection of the plurality of selected target features. The positioning may be based on the datum set of the plurality of target features. The first sensor may be, but not limited to, a camera or high speed camera. The second sensor may be, but not limited to, a touch probe. The second sensor may be actuated by, but not limited to, an air cylinder. Another step may be providing a light array in operative association with the first sensor. The light array may be a plurality of light emitting diodes.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiment as illustrated in the drawing, it will be recognized by those skilled in the art that various modifications may be made without departing from the spirit and scope of the invention. For example, in the implementation of the inspection method described herein, the inspection measures the hole location in two dimensions. However, in other applications, the method could be used to measure hole size or the orientation of the axis of the hole relative to the surface of the airfoil. Therefore, it is intended that the present disclosure not be limited to the particular embodiment(s) disclosed as, but that the disclosure will include all embodiments falling within the scope of the appended claims.

### INDUSTRIAL APPLICABILITY

Based on the foregoing, it can be seen that the present disclosure sets forth an inspection system having a camera and a touch probe. The touch probe may be actuated non-linearly with respect to the focal point of the camera, and specifically, may be actuated non-orthogonally with respect to a longitudinal axis of the camera. Traditional inspection systems that utilize linearly actuated touch probes require relatively large x-direction and/or y-direction offsets in order to avoid interference with the high speed camera and optical lens. This relatively large offset is reduced significantly with the non-linearly actuated touch probe of the present disclosure. The reduction of this offset, which may be approximately four inches, translates into a smaller work zone, smaller machine castings, shorter machine ways, shorter ball screws, shorter position scales, smaller bearings, less weight, smaller motors, faster speeds, and less required floor space, which ultimately results in significant overall savings costs.

What is claimed is:

1. An inspection system for inspecting a plurality of target features arrayed in spaced arrangement on a surface of a target object, the system comprising:
a position manipulator having a fixture for holding the target object;
a first sensor extending along a longitudinal axis; and
a second sensor in operative association with the position manipulator and the first sensor, the second sensor having a deployed position and a retracted position, the second sensor being actuatable between the retracted position and the deployed position at a non-orthogonal angle relative to the longitudinal axis, the second sensor in a deployed position being nominally coincident with a focal point of the first sensor.

2. The system of claim 1, further including an actuator in operative association with the second sensor for deployment and retraction of the second sensor.

3. The system of claim 1, wherein the first sensor is a camera and the second sensor is a touch probe.

4. The system of claim 3, further including a frame having a support section supporting a lens that is coupled to the camera.

5. The system of claim 4, wherein the support section includes a probe aperture, the probe aperture operatively associated with the touch probe such that the touch probe deploys and retracts through the probe aperture.

6. The system of claim 4, wherein the frame includes a light array mount for mounting a light array.

7. The system of claim 2, wherein the actuator is an air cylinder.

8. An inspection system for inspecting a plurality of target features arrayed in spaced arrangement on a surface of a target object, system comprising:
a position manipulator having a fixture for holding the target object;
a high speed camera, the high speed camera having an exposure duration of less than 3 milliseconds and configured to at least in part capture an image and determine a location of the target features, the high speed camera enabling inspecting of the plurality of selected target features without pause, movement of the selected target feature relative to the high speed camera over a duration of a frame capture being less than a predetermined fraction of a true position tolerance of the selected target feature, the high speed camera extending along a longitudinal axis;
a light array in operative association with the high speed camera;
a controller operatively associated with the high speed camera and with the position manipulator;
a processor operatively associated with the high speed camera for processing an image of a target feature received from the high speed camera; and
a touch probe in operative association with the position manipulator and the high speed camera, the touch probe having a deployed position and a retracted position, the touch probe being actuatable between the retracted position and the deployed position at a non-orthogonal angle relative to the longitudinal axis, the touch probe in the deployed position being nominally coincident with a focal point of the high speed camera.

9. The system of claim 8, further including an actuator in operative association with the touch probe for deployment and retraction of the touch probe.

10. The system of claim 9, wherein the actuator is an air cylinder.

11. The system of claim 8, further including a frame having a support section supporting a lens that is coupled to the camera.

12. The system of claim 11, wherein the support section includes a probe aperture, the probe aperture operatively associated with the touch probe such that the touch probe deploys and retracts through the probe aperture.

13. The system of claim 12, wherein the frame includes a light array mount for mounting a light array.

14. The system of claim 13, wherein the light array includes a plurality of light emitting diodes.

15. A method for inspecting a plurality of target features arrayed in spaced arrangement on a surface of a target object, the method comprising:
providing a fixture for holding the target object;
providing a first sensor extending along a longitudinal axis;
providing a second sensor in operative association with the fixture and the first sensor, the second sensor actuatable between a retracted position and a deployed position;
deploying the second sensor at a non-orthogonal angle relative to the longitudinal axis so that the second sensor, in the deployed position, is nominally coincident with a focal point of the first sensor;
determining, with the second sensor, a datum set of the plurality of target features;
retracting the second sensor; and
selectively positioning at least one of the fixture and the first sensor relative to the other for inspection, with the first sensor, of the plurality of selected target features.

16. The method of claim 15, wherein the first sensor is a camera.

17. The method of claim 15, wherein the second sensor is a touch probe.

18. The method of claim 15, wherein the second sensor is actuated by an air cylinder.

19. The method of claim 15, further including the step of providing a light array in operative association with the first sensor.

20. The method of claim 15, wherein selectively positioning at least one of the fixture and the first sensor relative to the other includes positioning based on the datum set of the plurality of target features.
